(19) United States
(12) Patent Application Publication
(10) Pub. No.: US 2017/0332566 A1
(43) Pub. Date: Nov. 23, 2017

(54) Soil Moisture Sensing Valves And Devices

(71) Applicant: Rain Bird Corporation, Azusa, CA (US)

(72) Inventors: Mark W. Emory, Fullerton, CA (US); Michael F. Turk, Porter Ranch, CA (US); Kevin Scott Judd, Irvine, CA (US); Samir Shah, Chino Hills, CA (US)

(21) Appl. No.: 15/523,093

(22) PCT Filed: Oct. 30, 2015
(86) PCT No.: PCT/US2015/058253

§ 371 Date: Apr. 28, 2017

Related U.S. Application Data
(60) Provisional application No. 62/073,549, filed on Oct. 31, 2014.
(60) Provisional application No. 62/138,861, filed on Mar. 26, 2015.
(60) Provisional application No. 62/147,411, filed on Apr. 14, 2015.

(51) Int. Cl. A01G 25/16; F16K 31/00; A01G 25/02

(52) U.S. Cl. CPC A01G 25/167; A01G 25/02; F16K 31/001

(57) ABSTRACT

There are provided soil moisture sensing valves and devices that use osmotic potential of an aqueous solution to control the state of the valves and devices, such as those used in irrigation systems.

### FIELD

The subject matter is directed to soil moisture sensing valves and devices and, more particularly, to a soil moisture sensing valve that uses osmotic potential of an aqueous solution to control the state of the valve.

### BACKGROUND

Irrigation systems are used to provide controlled watering to vegetation zones and specific plants. These systems often employ controllers using timed schedules. Sensors also are used to provide data used to modify the irrigation schedules in conjunction with the controllers or to override the irrigation schedules independent of the controllers based on environmental conditions, such as weather data or soil moisture.

One common type of sensor is a soil moisture-based sensor. Soil moisture based sensors have been used in conjunction with controllers and valves to control irrigation based on soil moisture measurements. By way of example, the sensor for a valve is embedded in the ground and senses the moisture content of the soil about the valve. If the moisture content is sufficient, it will maintain the valve in a closed position shutting off flow of water for irrigation. On the other hand, if the moisture content is insufficient for the vegetation, it will open the valve and permit water to flow downstream to the irrigation emission devices.

Some soil moisture sensing mechanisms for the valves use hygroscopic materials that expand or swell when in contact with moisture. The expansion of this material causes a valve element to move toward and eventually seat against a valve seat to shut off the water supply when there is sufficient moisture in the soil. When the water content of the soil dries, the material contracts and allows the valve element to move, such as under the bias of spring, away from the valve seat to open the valve to permit water to flow. Examples of such hydroscopic materials include cellulose fiber reinforced with rubber binders or gels.

Some of these hygroscopic materials have been found to hold on to the absorbed water to a greater degree than soil. In effect, they generally do not dry out unless the soil is so dry that a plant cannot survive. As a result, the valves controlled by these materials stay closed and do not permit the water to flow to the emission devices when needed.

Thus, there remains a need for a soil moisture sensing valve that is responsive to subtle variations in moisture conditions, reliable, long lasting and cost-effective to manufacture.

### DESCRIPTION OF THE DRAWINGS

FIG. 1 is a cross-sectional view of a soil moisture sensing valve in an opened state;

FIG. 2 is a cross-sectional view of the soil moisture sensing valve of FIG. 1 in a closed state;

FIG. 3 is a cross-sectional view of an irrigation emission device having a soil moisture sensing valve in an opened state;

FIG. 4 is a cross-sectional view of the irrigation emission device of FIG. 3 with the soil moisture sensing valve in a closed state;

FIG. 5 is a cross-sectional view of another irrigation emission device with a soil moisture sensing valve in an opened state;

FIG. 6 is a cross-sectional view of a soil moisture sensing valve controlling a diaphragm valve in a closed state;

FIG. 7 is a cross-sectional view of the soil moisture sensing valve and the diaphragm valve of FIG. 6 in an opened state;

FIG. 8 is layout schematic of an irrigation system using soil moisture sensing valves and emission devices with soil moisture sending valves embedded therein;

FIG. 9 is an elevational view of a moisture sensing emitter configured for watering;

FIG. 10 is an elevational view of a moisture sensing valve configured for watering;

FIG. 11 is an elevational view of a multi-outlet moisture sensing emitter configured for watering; and

FIG. 12 is an elevational view of a multi-outlet sensing valve configured for watering;

FIG. 13 is a cross-sectional view of an irrigation emission device having a soil moisture sensing valve with diaphragm and spring in an opened state;

FIG. 14 is a cross-sectional view of the irrigation emission device of FIG. 13 with the soil moisture sensing valve with diaphragm and spring in a closed state; and

FIG. 15 is a cross-sectional view of another irrigation emission device with a soil moisture sensing valve with diaphragm and spring in an opened state;

FIG. 16 is an elevational view of a moisture sensing emitter stake unit configured for watering;

FIG. 17 is an elevational view of an alternative embodiment of a moisture sensing emitter stake unit configured for watering:

FIG. 18 is an elevational view of a moisture sensing valve stake unit configured for watering;

FIG. 19 is an elevational view of a multi-outlet moisture sensing emitter stake unit configured for watering;

FIG. 20 is an elevational view of a multi-outlet moisture sensing valve stake unit configured for watering;

FIG. 21 is a cross-sectional view of an alternative embodiment of a soil moisture sensing valve in stake form in an opened state;

FIG. 22 is a cross-sectional view of an irrigation emission device for regulating irrigation in response to soil moisture; and

FIG. 23 is a cross-sectional view of an alternative embodiment of a soil moisture sensing valve in stake form in an opened state.

### DESCRIPTION OF PREFERRED EMBODIMENTS

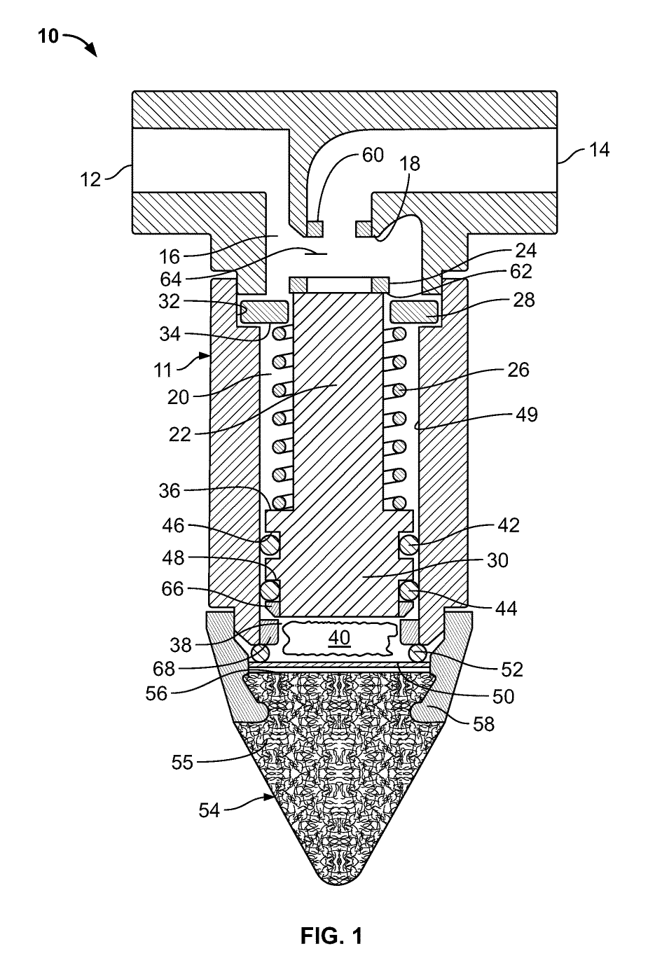

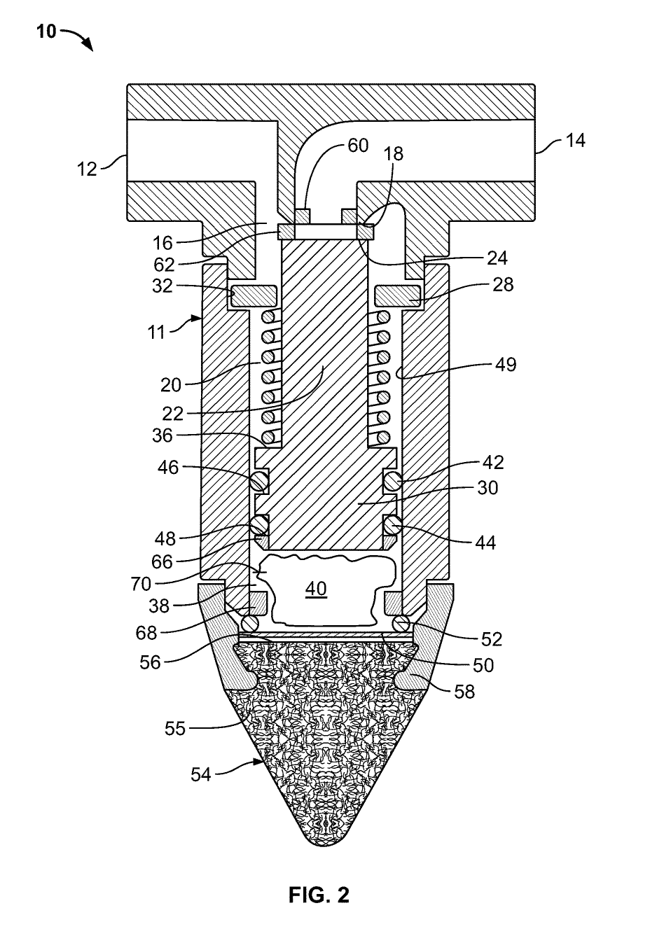

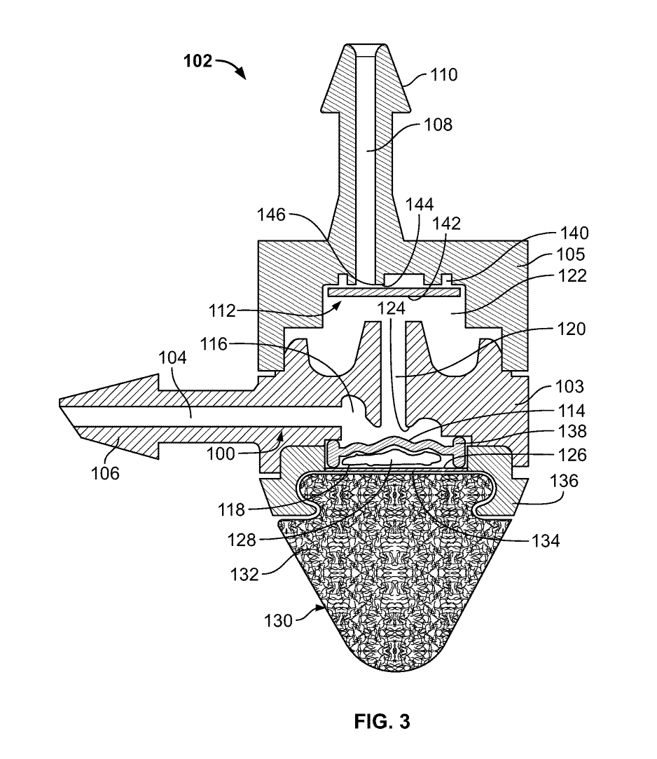

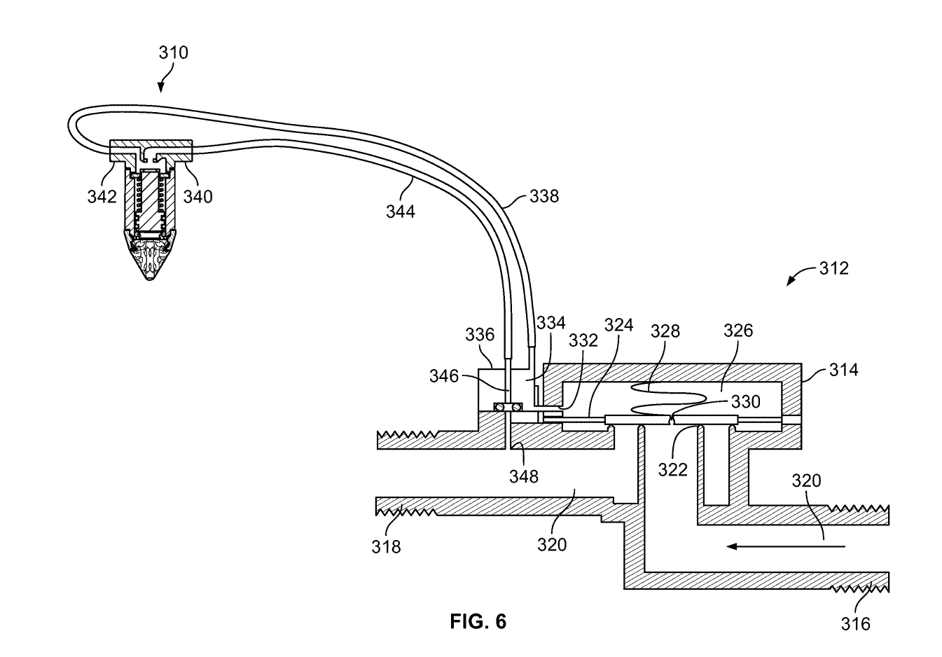

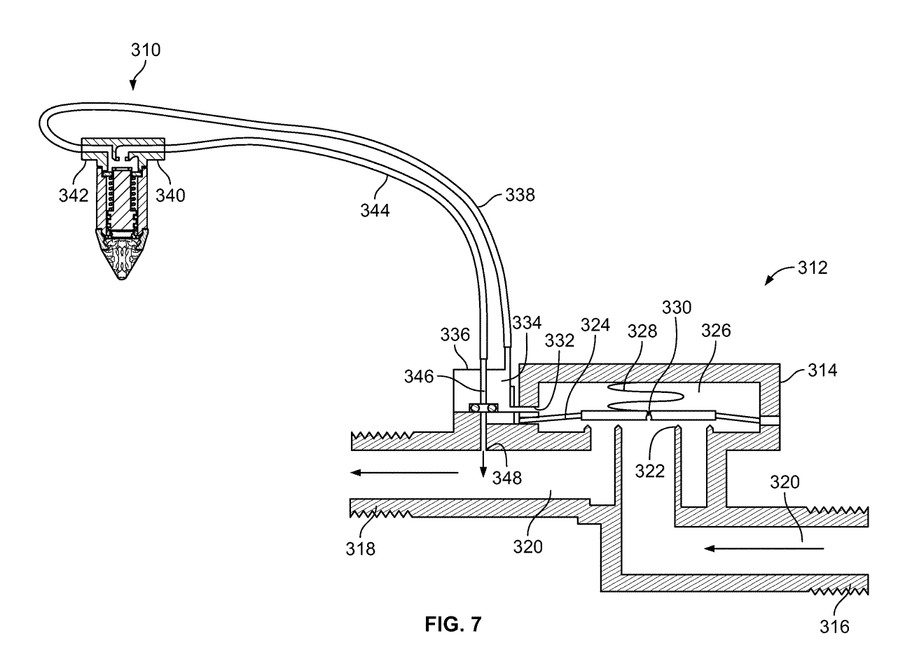

With reference to FIGS. 1 and 2, there is illustrated a soil moisture sensing valve 10 triggered using osmotic potential. The valve 10 has an open state (FIG. 1) that permits water flow and a closed state (FIG. 2) that prohibits water flow. The valve 10 can be used as a standalone valve, as illustrated, to provide on-demand water flow to a watering zone or an irrigation device. A valve using osmotic potential also can be embedded into a watering device, such as a sprinkler or drip emitter (FIGS. 3-5), to provide on-demand irrigation at a specific location or plant, or used as a pilot valve for larger valves (FIGS. 6 and 7), such as those used to control irrigation zones. The on-demand nature helps provide the proper amount of water to the vegetation without under and/or overwatering. This is advantageous because it allows plants to be irrigated based on the actual soil moisture needs and conditions local to the plants, as opposed to being watered based on other methods that do not take into account local soil moisture content or rely on soil moisture measurements taken at locations remote from the plants being watered. As a result, on-demand watering based on osmotic potential, such as with the valves discussed below, addresses the effects of improper watering and needless water consumption.

Referring to FIGS. 1 and 2, the valve 10 includes a valve body 11 defining an inlet 12, an outlet 14, a passage 16 extending between the inlet 12 and the outlet 14, and a valve seat 18 located along the passage 16. While the valve 10 only has a single outlet, it could be modified to have multiple outlets to serve more than one irritation zone or emission device.

The valve body 11 defines an elongated chamber 20 extending below the valve seat 18. A valve piston or plunger 22 reciprocates in the elongated chamber 20. The valve plunger 22 includes an enlarged valve end 24 that engages the valve seat 18 to close the valve 10. The valve end 24 can include a rubber material that enhances sealing against the valve seat 18. An elastic member (spring 26) biases the plunger 22 away from the valve seat 18 to the open position for the valve 10. The spring 26 operates between a spring retainer 28 near the enlarged valve end 24 and an opposite enlarged lower end 30 of the plunger 22. The spring retainer 28 resides in a groove 32 and provides a first shoulder 34 that engages one end of the spring 26. The enlarged lower end 30 of the plunger 22 includes a second shoulder 36 facing the spring retainer 28, and the other end of the spring 26 engages this shoulder 36.

A polymer chamber 38 is located below the enlarged lower end 30 of the plunger 22 and is sealed in order to contain a water soluble polymer material 40. The water soluble material 40 could be, for example, one of polyethylene glycol, polyacrylamide, polyvinyl-pyrrolidone and polyethylene oxide. It is preferred that the water soluble material 40 not be a material that exists naturally in soil. The enlarged lower end 30 of the plunger 22 closes one end of the polymer chamber 38. Two o-rings 42, 44 are fitted into two grooves 46, 48 defined by the enlarged lower end 30 of the plunger 22 and seal against an inner surface 49 of the elongated chamber 20 to close the end of the polymer chamber 38 at the plunger 22. A semi-permeable membrane 50 seals the other side of the polymer chamber 38 opposite the plunger 22. The membrane 50 allows bidirectional flow of water but retains the soluble polymer material 40 within the polymer chamber 38. A third o-ring 52 is situated between the semi-permeable membrane 50 and the valve body 11 to further seal the polymer chamber 38. The chamber 38 is collapsible/expandable so that it is variable in size (volume) in response to the amount of moisture in the chamber 38. The at rest size of the chamber 38 (i.e., when the chamber 38 is in an unexpanded state) may also be adjusted based on the nature of the soil in which the valve 10 is to be used, and this at rest size is independent of the operational engagement of the water soluble material 40 with the plunger 22.

The valve 10 includes a porous tip 54 extending from the valve body 11 below the semi-permeable membrane 50. The porous tip 54 includes small passages 55 that enable moisture to travel via capillary action to the semi-permeable membrane 50, while filtering out unwanted debris, and back to the soil. The porous tip 54 includes a relatively flat surface 56 that faces the polymer chamber 38. The semi-permeable membrane 50 can be a separate membrane material, such as a reverse osmosis (RO) membrane, supported by the surface 56 of the porous tip 54 or a ceramic membrane layer attached directly on the surface 56. A holding ring 58 secures the porous tip 54 to the valve body 11 of the valve 10. This attachment may be done by any conventional technique, including, for example, a friction or snap fit, a weld or an adhesive.

When the soil local to the valve 10 is sufficiently wet, the moisture travels through the porous tip 54. The water soluble polymer material 40 in the polymer chamber 38 causes the moisture to travel across the semi-permeable membrane 50 into the polymer chamber 38. More specifically, in accordance with osmotic potential, water in the less concentrated solution (soil) will seek to dilute the more concentrated solution (polymer chamber), and thus, moisture will pass through the semi-permeable membrane 50 from the soil side to the polymer side. Once in the polymer chamber 38, the moisture will dilute the soluble polymer material 40 in proportion to the amount of moisture in the local soil. The pressure inside the polymer chamber 38 will increase until osmotic potential equilibrium is reached across the membrane 50. The pressure inside the polymer chamber 38 increases and overcomes the bias of the spring 26 and urges the plunger 22 to seat the valve end 24 on the valve seat 18 to close the flow of water through the valve 10 (FIG. 2).

As the soil local to the valve 10 dries, the osmotic potential in the soil becomes different than that in the polymer chamber 38. The moisture in the polymer chamber 38 passes back through the semi-permeable membrane 50 to the soil through the porous tip 54, and the pressure in the polymer chamber 38 lowers. As the pressure lowers, the bias of the spring 26 moves the plunger 22 and, in turn, the valve end 24 away from the valve seat 18 to allow water to flow through the valve 10. The amount of movement of the valve end 24 away from the valve seat 18 will variably depend on the moisture content levels of the local soil.

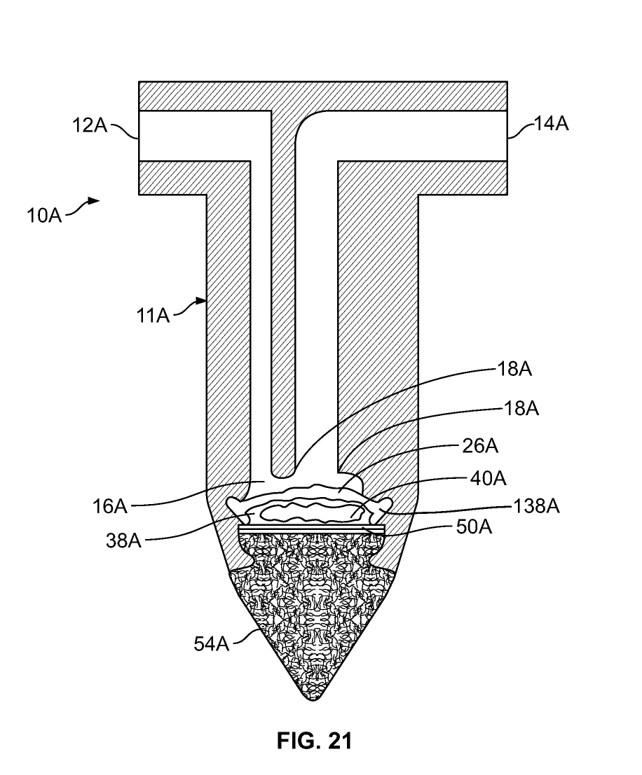

As should be evident, variations in the geometry and nature of the components of the valve 10 are possible. For example, as shown in FIG. 21, the valve 10 may be modified so that the passage 16 and valve seat 18 are disposed at or near the porous tip 54. More specifically, the valve 10A (shown in an open state) includes a valve body 11A defining an inlet 12A, an outlet 14A, a passage 16A extending between the inlet 12A and the outlet 14A, and a valve seat 18A located along the passage 16A. In this form, the elastic member (spring 26) has been replaced with another form of elastic member (diaphragm 26A) that is disposed near the porous tip 54A (although valve 10A might also use a spring alone or in combination with a diaphragm at or near the porous tip 54A). As with valve 10 (described above), when the soil local to the valve 10A is sufficiently wet, the moisture travels through the porous tip 54A, and the water soluble polymer material 40A in the polymer chamber 38A causes the moisture to travel across the semi-permeable membrane 50A into the polymer chamber 38A. The pressure inside the polymer chamber 38A increases and overcomes the bias of the diaphragm 26A and urges the diaphragm 26A against the valve seat 18A to close the flow of water through the valve 10A. As the pressure lowers, the bias of the diaphragm 26A moves away from the valve seat 18A to allow water to flow through the valve 10A. The diaphragm 26A includes a bead 138A about its circumferential perimeter to seal the chamber 38A. The structure and operation of valve 10A are otherwise generally similar to that of valve 10.

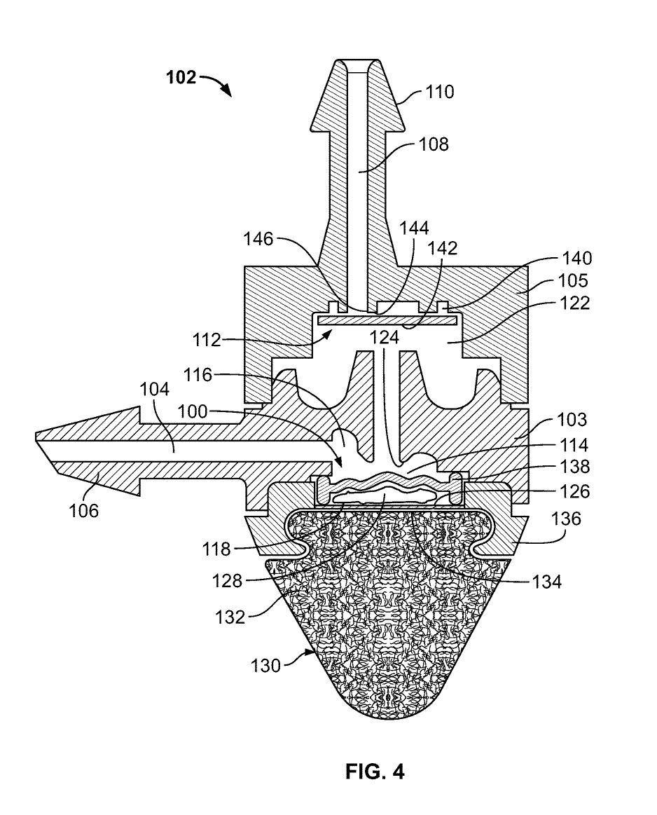

With reference to FIGS. 3 and 4, there is illustrated a soil moisture sending valve 100 embedded into a drip type emitter 102. Valve 100 operates on the same osmotic potential principles described above for valve 10. While not illustrated, the valve 100 (or valves 10, 10A) could be embedded into any number of irrigation devices, including, for example, a pop-spray sprinkler, an impact sprinkler, and an emitter embedded in-line in drip irrigation tubing.

The drip emitter 102 includes an inlet and valve seat body 103 and a flow regulating body 105. The inlet and valve seat body 103 includes an inlet passage 104 with a first barb 106 for attaching a supply tube. The flow regulating body 105 includes an outlet passage 108 for delivering water directly from the emitter 102 or through a tube attached to a second barb 110. The valve 100 is intermediate the inlet and outlet passages 104, 108 in the inlet and valve seat body 103 for controlling the flow of water through the emitter 102 in an on-demand manner, and a flow regulator 112 is positioned downstream of the valve 100 in the flow regulating body 105 to regulate flow emitted from the drip emitter 102.

The valve 100 includes a diaphragm 114 mounted in the inlet and valve seat body 103 to separate an inlet chamber 116 from a polymer chamber 118. The inlet passage 104 leads into the inlet chamber 116. A transfer passage 120 extends from the inlet chamber 116 to a regulator chamber 122, which causes a pressure drop. The transfer passage 120 defines a valve seat 124 at the inlet chamber 116. The diaphragm 114 is configured to naturally bias away from the valve seat 124 but can be urged against this bias toward the valve seat 124 to control flow or eventually to engage the valve seat 124 to prevent water flow through the valve 100 and out from the emitter 102.

A semi-permeable membrane 126 located opposite from, but facing, the diaphragm 114 defines a portion of the polymer chamber 118. A water soluble polymer material 128, such as, for example, polyethylene glycol, polyacrylamide, polyvinyl-pyrrolidone or polyethylene oxide, is contained in the polymer chamber 118 between the diaphragm 114 and the semi-permeable membrane 126. The membrane 126 allows bidirectional flow of moisture through the membrane but retains the soluble polymer material 128 within the polymer chamber 118.

The valve 100 also includes a porous tip 130 attached below the semi-permeable membrane 126. The porous tip 130 includes small passages 132 that supply moisture via capillary action back and forth between the semi-permeable membrane 126 and the soil. The passages 132 filter out unwanted debris of the soil. The porous tip 130 includes a relatively flat surface 134 that faces the polymer chamber 118 and the membrane 126. The semi-permeable membrane 126 can be a separate membrane material, such as a reverse osmosis (RO) membrane, supported by the surface 134 of the porous tip 130 or a ceramic membrane layer attached on the surface 134 of the porous tip 130. A holding ring 136 secures the porous tip 130 to the inlet and the valve seat body 103 of the emitter 102. This attachment may be done by any conventional technique, including, for example, a weld, a friction or snap fit or an adhesive. The diaphragm 114 includes a bead 138 about its circumferential perimeter that is sandwiched between the inlet and valve seat body 103 and the membrane 126, which is supported by the porous tip 130, to seal the polymer chamber 118.

The flow regulator 112 of the emitter 102 is downstream of the valve 100 and is designed to reduce water emission to a specified rate, such as 0.5 gallons per hour (gph), 1.0 gph, 2.0 gph, etc. For example, a tortuous path 140 may be defined in the regulator chamber 122 to reduce the flow of water from the emitter 102. To regulate pressure, a diaphragm 142 may overlay the tortuous path 140 and constricts the tortuous path 140 as the pressure in the regulator chamber 122 rises to adjust the flow from the emitter 202 in a pressure compensating manner. The diaphragm 142 may also constrict a metering groove 144 adjacent an entrance 146 to the outlet passage 108 to provide further pressure compensation as pressure in the regulator chamber 122 rises or falls based on the supply pressure.

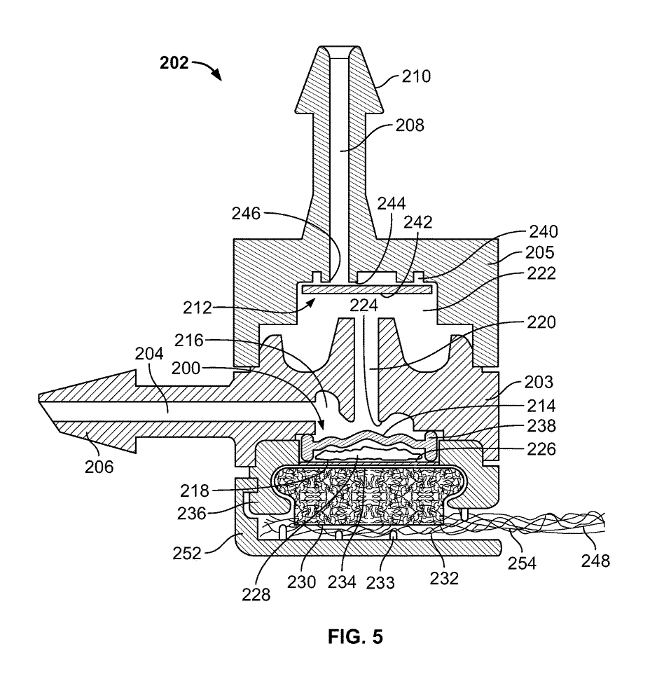

With reference to FIG. 5, there is illustrated another emitter with a valve 200 being embedded into an alternative drip emitter 202. Valve 200 operates on the same principles as described above for valve 10.

The drip emitter 202 includes an inlet and valve seat body 203 and a flow regulating body 205. The inlet and valve seat body 203 includes an inlet passage 204 with a first barb 206 for attaching a supply tube. The flow regulating body 205 includes an outlet passage 208 for delivering water directly from the emitter 202 or through a tube attached to a second barb 210. The valve 200 is intermediate the inlet and outlet passages 204, 208 in the inlet and valve seat body 203 for controlling the flow of water through the emitter 202 in an on-demand manner, and a flow regulator 212 is downstream of the valve 200 to regulate the flow emitted from the drip emitter 202.

The valve 200 includes a diaphragm 214 in the inlet and valve seat body 203 to separate an inlet chamber 216 from a polymer chamber 218. The inlet passage 204 leads into the inlet chamber 216. A transfer passage 220 extends from the inlet chamber 216 to a regulator chamber 222, which causes a pressure drop. The transfer passage 220 defines a valve seat 224 at the inlet chamber 216. The diaphragm 214 is configured to naturally bias away from the valve seat 224 but can be urged against this bias toward the valve seat 224 to control flow or eventually to engage the valve seat 224 to prevent water flow through the valve 200 and out from the emitter 202.

A semi-permeable membrane 226 located opposite from, but facing, the diaphragm 214 defines a portion of the polymer chamber 218. A soluble polymer material 228, such as, for example, polyethylene glycol, polyacrylamide, polyvinyl-pyrrolidone or polyethylene oxide, is contained in the polymer chamber 218 between the diaphragm 214 and the semi-permeable membrane 226. The membrane 226 allows bidirectional flow of moisture through the membrane 226 but retains the soluble polymer material 228 within the polymer chamber 218.

The valve 200 also includes a porous body 230 attached below the semi-permeable membrane 226. The porous body 230 includes small passages 232 that supply moisture via capillary action back and forth between the semi-permeable membrane 226 and the soil. The passages 232 filter out unwanted debris of the soil. The porous body 230 includes a relatively flat surface 234 that faces the polymer chamber 218 and the membrane 226. The semi-permeable membrane 226 can be a separate membrane material, such as a reverse osmosis (RO) membrane, supported by the surface 234 of the porous body 230 or a ceramic membrane layer attached on the surface 134 of the porous body 230. A holding ring 236 secures the porous body 230 to the inlet and valve seat body 203 of the emitter 202. This attachment may be done by any conventional technique, including, for example, a weld, a friction or snap fit or an adhesive. The diaphragm 214 includes a bead 238 about its circumferential perimeter that is sandwiched between the inlet and valve seat body 203 and the membrane 226, which is supported by the porous tip, to seal the polymer chamber 218.

The flow regulator 212 of the emitter 202 is downstream of the valve 200 and is designed to reduce water emission to a specified rate, such as 0.5 gallons per hour (gph), 1.0 gph, 2.0 gph, etc. For example, a tortuous path 240 may be defined in the regulator chamber 222 to reduce the flow of water from the emitter 202. To regulate pressure, a diaphragm 242 may overlay the tortuous path 440 and constricts the tortuous path 240 as the pressure in the regulator chamber 222 rises to adjust the flow from the emitter 202 in a pressure compensating manner. The diaphragm 242 may also constrict a metering groove 244 adjacent an entrance 246 to the outlet passage 208 to provide further pressure compensation as pressure in the regulator chamber 222 rises or falls based on the supply pressure.

A flexible wicking or flexible capillary material 248 acts as a moisture path between the soil and the porous body 230. The wicking material may be of the type used in capillary mats for hydroponic farming. The wicking material 248 extends from the soil into direct contact with a surface 250 of the porous body 230. The wicking material 248 improves the coupling with the soil. A retainer body 252 attaches the wicking material to the emitter 202. The retainer body 252 includes a number of protrusions 254 that stake the wicking material 248 so that the wicking material 248 does not separate from the emitter 202. The retainer body 252 attaches to the holding ring 236 for the porous body 230. The retainer body 252 can be secured to the holding ring 236 by way of any conventional technique, including, for example, a weld, friction or snap fit or adhesive.

If the valve or emitter is buried in the soil so that the outlet is also buried, then copper metal can be used at the outlet to prevent roots from blocking flow from the outlet. Copper metal will inhibit root growth into the outlets. The copper member can be a ring inset into the outlet or around the outside of the outlet. The copper could also be co-molded to the inside or outside of the outlet or embedded in the body material near the outlet.

The soil matric potentials at which the standalone valves 10, 10A and the embedded valves 100, 200 begin to restrict water flow or allow water flow can be tuned to fit the watering environment, such as, for example, the different type of soils, which range from sandy to clay and many combinations in between. The size of the polymer chamber, the amount of the polymer material in the polymer chamber and/or the biasing force of the spring or the diaphragm, as the case may be, can be used to set and change the operating parameters of the valve. The valves can be preset from the factory for a certain set of conditions or can be made adjustable in the field. In the field, for example, the valve body can be adjustable to change the size of the poly chamber or the polymer chamber can be accessible to add or remove amounts of polymer material. Alternatively (or additionally), the valve can be adjusted to change the preload of the spring or designed to be opened so that the spring or diaphragm can be interchangeable with ones with more or less biasing force as the situation may require.

If wetter soil or low matric potential (such as 10 kPa) is desired before restricting water flow, then a greater biasing force is needed for the spring or diaphragm before the valve closes. Conversely, if dryer soil or a higher matric potential (such as 30 kPa) is desired, then less biasing force is needed for the spring or diaphragm. Alternatively, for example, sandy type soil may require more biasing force to maintain the valve open because it tends to be drier soil, while clay type soil may require less biasing force to allow the valve to be closed more easily because it tends to be wetter soil.

In addition, the valves described herein can make use of a trigger point to open and close the valve. More specifically, the valves may be configured so that, when the spring 26 or diaphragm 26A/114/214 reaches a certain trigger position, the valve snaps either open or closed. In this arrangement, the valves would not open or close gradually but instead would alternate between either a fully open position or a fully closed position. For example, one or more magnets may be used to cause the valve to snap shut (fully closed) after the spring 26 or diaphragm 26A/114/214 has reached a certain trigger position where the magnet(s) attract the valve plunger 22 to valve seat 18 or the diaphragm 26A/114/214 to valve seat 18A/124/224. The opposite may be used as well where magnets snap open the valve based on a predetermined movement of the plunger or diaphragm.

For example, as shown in FIGS. 1 and 2, one or more magnets 60 may be placed at or near the valve seat 18. Similarly, the valve end 24 may include a magnetic portion 62, such that when the valve end 24 reaches a trigger (or threshold) position 64, the magnetic force is sufficient to attract the valve end 24 to the valve seat 18. Additionally, magnetic portions 66, 68 may be included both in the valve body 11 adjacent the chamber 38 and in the lower end 30 of the plunger 22. When the lower end 30 of the plunger 22 reaches a certain threshold position 70, these magnetic portions 66, 68 may attract the lower end 30 to the valve body 11. The magnets and magnetic portions are preferably selected so as not to interfere with the general expansion and contraction of chamber 38.

The valve seat for either the standalone valves 10, 10A or the emitter valves 100, 200 also could be provided with a small groove that would allow for a minimum bypass flow. Irrigation zones incorporating low pressure tubing and fittings along with a dynamic pressure regulator to maintain that low pressure would need this bypass flow in order to ensure there is enough flow for the dynamic pressure regulator to function. If no bypass was used and all soil moisture sensing devices were in the closed position, then the dynamic pressure regulator would no longer be able to regulate pressure to the zone, and the static pressure in that zone would reach full line pressure. If full unregulated line pressure was reached, then the tubing, fittings and/or connections could fail and cause leakage.

Any embodiment that will emit water directly from the device also can be designed or adapted to emit the water at an optimum distance. This distance can be selected based upon various use variables, such as soil type, plant type, placement of the device, burial depth of the device, or other known variables.

The valve 10/10A and emitter 102/202 described above may also include anti-oxidant, anti-microbial, and/or anti-fungal additives to resist breakdown of the water soluble polymer material. These additives may be incorporated in several different ways. First, these additives may be mixed in directly with the water soluble polymer material itself in the chamber 38/38A/118/218. One example of such an additive is the anti-oxidant BHT, which may be in powder form and may be mixed in with powdered water soluble polymer material. Second, additives may be added to the porous tip 54/54A/130, porous body 230, or capillary 248 material, such as homogenously or in the form of a coating. Third, additives may be mixed in with other ingredients to form the valve/emitter housing or diaphragm 26A/114/214 material. Further, the valve 10/10A and emitter 102/202 may also include additives to inhibit plant root intrusion into these devices. More specifically, the porous tip 54/54A/130, porous body 230, or capillary 248_material may include an additive, such as copper, that inhibits root intrusion. For example, the porous tip 54/54A/130, porous body 230, or capillary 248 material may be metal injection molded with a copper blend, or copper or a copper blend may be applied as a coating to the porous tip 54/54A/130, porous body 230, or capillary 248. This additive may inhibit roots attracted by moisture from growing into these portions of valve 10/10A and emitter 102/202.

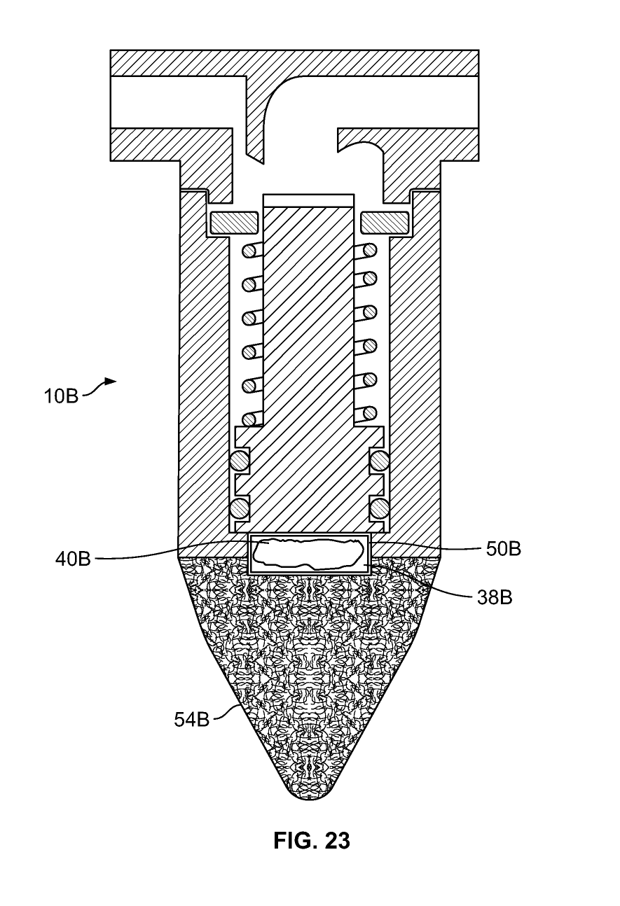

Moreover, the geometry of the chamber may be modified to seek to make response times faster. In one form, as shown in FIG. 23, the valve 10 (FIG. 1) may be modified so that a portion of the porous tip 54 is hollowed out to form the chamber therein. More specifically, the valve 10B (shown in an open state) includes a chamber 38B formed in a recess in the porous tip 54B and containing the water soluble polymer material 40B. In this form, the semi-permeable membrane may be disposed on three sides of chamber 38B, and the water soluble polymer material 40B in the chamber 38B causes the moisture to travel across the membrane 50B into the polymer chamber 38B. The close proximity of the water soluble polymer material 40B to the soil shortens the leach path and may increase the responsiveness of the material 40B with respect to changes in the moisture of the soil. As can be seen, in this example, the structure and operation of valve 10B are otherwise generally like that of valve 10.

In addition, the porous tip 54/54A/130 and porous body 230 may be made of various types of materials and processes. For example, the porous tip 54/54A/130 and porous body 230 may be composed of ceramic, porous sintered metal (powdered metal process), porous metal injection molding (MIM), a screen, or screen/fabric combinations. The porous MIM material may use metal particles in conjunction with low melt plastics or wax. The screen/fabric combinations may help with the connection with the soil and may be used in capillaries 248 or in a capillary mat.

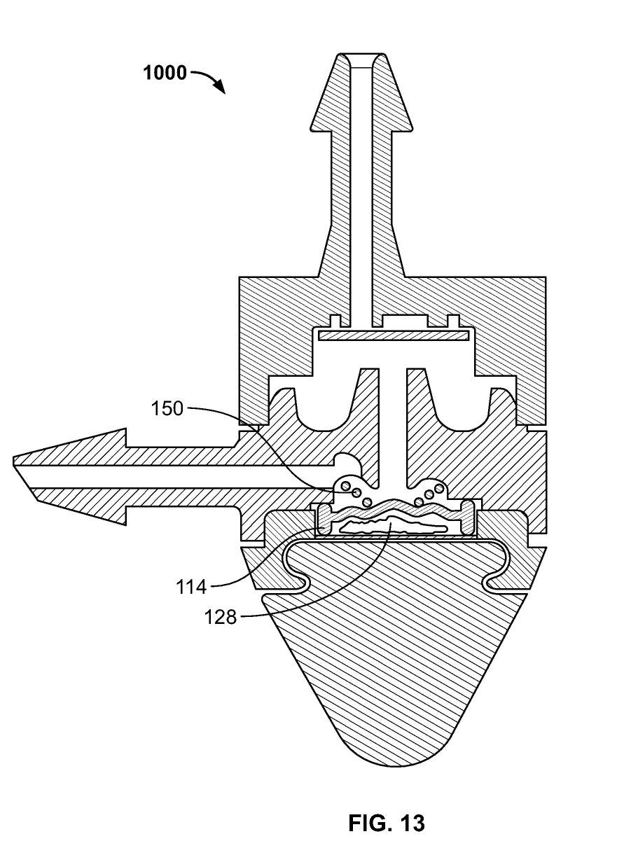

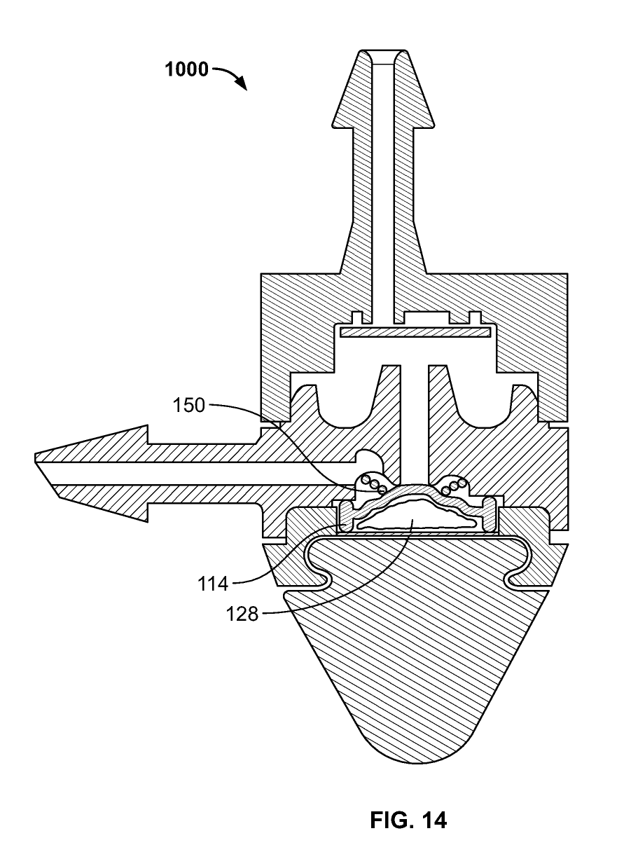

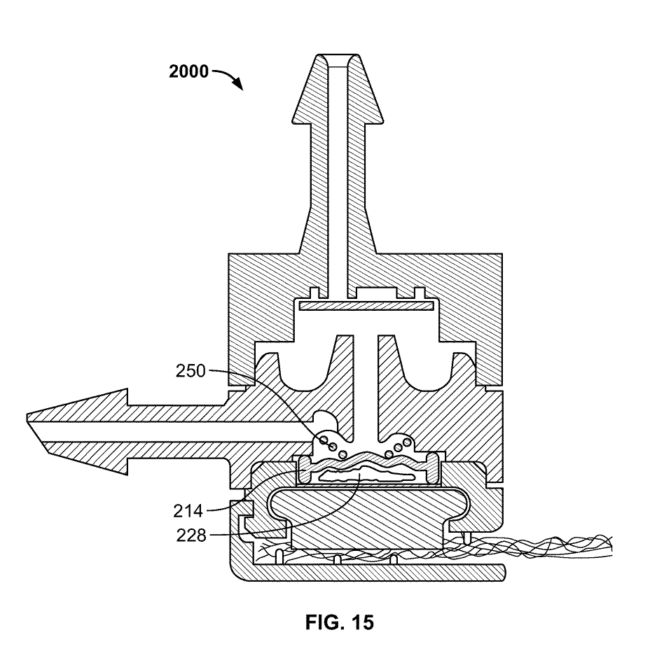

FIGS. 13, 14, and 15 show alternative embodiments 1100, 1200 to the valves 100, 200 shown in FIGS. 3, 4, and 5. In these alternative embodiments 1100, 1200, a spring member 150, 250 has been added such that the alternative embodiments each include both a spring member 150, 250 and a diaphragm 114, 214, respectively. The spring member 150, 250 may be added to work in concert with the diaphragm 114, 214 so as to provide the sufficient and/or additional desired preload depending on the desired matric potential range. Also, as should be evident, a spring member 150, 250 may be used without any diaphragm 114, 214 at all. The general discussion relating to the characteristics of and options for valves 100, 200 applies equally to valves 1100, 1200.

There are additional options and embodiments available that may be used in conjunction with the valves and emitters described above. For example, in the stake embodiments, depth markings could be added on the side of the stake in inch/mm increments. Alternatively (or in combination), pictures of plant types, e.g., grass, bush, or tree, could be added along the side of the stake. The measurements or images would help simplify installation. As another example, the stake embodiments could be made to be adaptable to accommodate a plant's growth over time, such as by making the stake relatively long (so a user can push the stake in further each year), making the length of the stake adjustable, or making the stake easily removable from the soil so that it can be placed periodically in a new position further from the plant.

The valve 10, 10A described above mechanically controls flow from off to full on and variably between such limits. However, to directly control flow of relatively large amounts of water, such as that used in irrigation, the valve 10, 10A also would have to be relatively large. In order to scale down the size of the soil moisture sensing valve relative to the water flow requirements, valve 10, 10A (or valve 100, 200) could be employed as a pilot valve for controlling a larger valve. For example, as illustrated in FIGS. 6 and 7, a pilot valve 310 controls the operation of a larger main valve 312. The main valve 312 could be similar to diaphragm valves commonly used to control zones in irrigation systems. A solenoid actuated pilot valve is commonly used with these types of valves. The solenoid type pilot valve could be replaced with the osmotic potential soil moisture sensing pilot valve 310. The pilot valve 310 may be identical to the valve 10, 10A described above with reference to FIGS. 1 and 2, or it may adopt the forms of valve 100 (FIG. 3) or valve 200 (FIG. 5). When the pilot valve 310 is opened, the main valve 312 also opens to permit flow, and when the pilot valve 310 is closed, the main valve 312 closes to prohibit flow.

More specifically, the main valve 312 includes a valve body 314 defining a valve inlet 316 and a valve outlet 318. A flow passage 320 interconnects the valve inlet 316 to the valve outlet 318, and a valve seat 322 is located along the passage 320. A diaphragm 324 is situated over the valve seat 322 and operates to engage the valve seat 322 to shut off flow through the main valve 312 and to move away from the valve seat 322 to enable flow through the main valve 312. The valve body 314 and the diaphragm 324 define a pressure chamber 326 on the side of the diaphragm 324 opposite of the valve seat 322. A spring 328 is positioned in the pressure chamber 322 and biases the diaphragm 324 towards the valve seat 322.

The diaphragm 324 includes a small port 330 to allow a small amount of water from the valve inlet 316 to pass through the diaphragm 324 into the pressure chamber 326, even when the diaphragm 324 is engaged with the valve seat 322 in the closed position. The pressure chamber 326 includes a small outlet port 332 that allows water to flow from the pressure chamber 326 to the pilot valve 310. More specifically, the outlet port 332 leads into a first internal passage 334 through an adapter 336. The adapter 336 can be designed to thread into a threaded socket normally designed for a solenoid valve. The adapter 336 communicates with an outlet conduit 338 that provides water flow from the adapter 336 to an inlet 340 of the pilot valve 310. An outlet 342 of the pilot valve 310 communicates water flow from the pilot valve 310 back to the adapter 336 through a return conduit 344. A second internal passage 346 of the adapter 336 leads to a dump port 348 downstream of the valve seat 322 and the diaphragm 324.

In operation, the pilot valve 310 is located sufficiently remote from the main valve 312 and within the soil area being watered so that it is controlled by the amount of moisture content in such soil. The pilot valve 310 operates using osmotic potential as explained above for valve 10. When the pilot valve 310 closes (FIG. 6), water flow from the pressure chamber 326 is shut off, and the pressure in the pressure chamber 326, coupled with the bias of the spring 328, seats the diaphragm 324 on the valve seat 322 to shut off water flow through the main valve 312. Conversely, when the pilot valve 310 opens (FIG. 7), water flows from the pressure chamber 326 to the dump port 348, and the pressure in the pressure chamber 326 drops. The pressure eventually drops to a point where the pressure from the water from the valve inlet 316 overcomes the bias of the spring 328 and any remaining fluid pressure in the pressure chamber 326 and moves the diaphragm 324 away from being in engagement with the valve seat 322. This allows water to flow through the main valve 312 from the valve inlet 316 to the valve outlet 318.

The valve mechanisms described above mechanically operate to open and close the valve. The mechanisms also could be used to electronically trigger a valve to open or close. For example, the pressure created by the polymer material in the polymer chamber could trigger a switch that authorizes an electrical control signal to be sent to a valve, such as a solenoid valve, to open or close the valve. Further, since the valve mechanism can be designed to move variably relative to soil moister levels, such as 0.010 inch travel per 10 kPa, a measuring device could be used to measure this movement. Alternatively, the size of the chamber could be monitored. This variable position or size measurement, which can be correlated with soil moisture levels, could be used to communicate the soil moisture levels to a compatible controller or valve. The controller or valve could then be programmed to use that information to calculate the amount of water needed during a future watering cycle, such as increasing or decreasing, the watering cycle time, or interrupting a watering schedule to stop, prevent or suspend watering.

As stated, the osmotic material can be used to act as a microswitch in various electronic applications. For example, the osmotic material can be used in a system to interrupt execution of one or more watering schedules of an irrigation controller based on its detection of moisture. The system may make use of a moisture threshold value, and in such a system, the fact that the switch is triggered indicates to the electronics that the threshold has been exceeded and the watering schedule should be interrupted.

Additionally, the osmotic material may be used in electronic applications to provide continuously variable (or analog continuous) measurements or signals indicative of the amount of moisture in the soil. For example, the osmotic material may be used in systems in conjunction with strain gauges, capacitors, inductors, resistors, Hall effect devices, linear potentiometers, linear variable differential transformers, and other sensors that can measure changes corresponding to the degree of expansion of the chamber. In this example, if the sensor is coupled to a spring reacting to the chamber (such as in FIG. 1), the sensor can measure the amount of change in force, position, or electrical/magnetic characteristics corresponding to the degree of expansion of the chamber. The sensed change in force, position, or electrical/magnetic characteristics may provide an analog continuous measurement corresponding to the amount of moisture in the soil. In one application, the value of the change in force, position, or electrical/magnetic characteristics may be transmitted to an interface for a determination of whether a moisture threshold has been exceeded or such a determination may be transmitted to the interface.

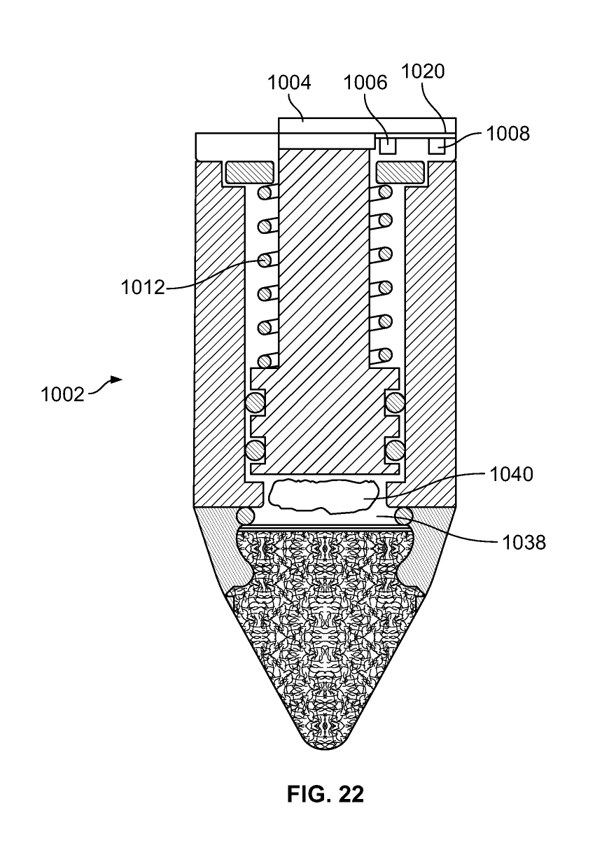

FIG. 22 is a modified version of FIG. 1 and shows an example of a sensor unit 1002 using the osmotic material 1040 coupled to a sensor 1004. The sensor unit 1002 generates a signal indicative of the amount of moisture in the soil. The sensor unit 1002 may include a power source (battery and/or solar cell) 1006, a wireless transmitter 1008, and other circuitry and other components. A signal representing a sensed value that corresponds to an amount of moisture may be transmitted to an interface unit. In some forms, the interface unit may be configured to interpret the information in the signal and correlate that information to a corresponding level of moisture. In other embodiments, the signal may be converted to a corresponding level of moisture prior to being transmitted to the interface unit. Still further in some implementations, the sensor unit 1002 determines whether a threshold level of moisture is present and transmits an indication of whether the threshold is exceeded in response to an inquiry from the interface unit.

As can be seen in FIG. 22, the osmotic material is again used to urge the spring 1012 upwardly when the chamber 1038 expands. In this form, the sensor unit 1002 includes a strain gauge 1004 (sensor) coupled to a printed circuit board 1020 and that engages the spring 1012 when the chamber 1038 expands. Expansion of the chamber 1038 changes the force applied to the strain gauge 1004 by the spring 1012. The spring 1012 may initially contact the strain gauge 1004 or not. This change in force on the strain gauge 1004 is detected by appropriate electronics on the printed circuit board 1020 comprising the sensor electronics. In some embodiments, the printed circuit board 1020 may comprise a controller, memory, transceiver and/or other relevant elements. The sensed force provides an analog continuous measurement corresponding to the amount of moisture in the soil (and may be converted to a digital signal by an analog-to-digital converter). The value of this sensed force may be transmitted to an interface unit for a determination of whether a moisture threshold has been exceeded and/or a determination of whether a threshold is exceeded may be transmitted to the interface unit.

As should be evident, other types of sensors 1004, besides a strain gauge, may be used. In another form, a metal piece may be mounted at or near the expandable surface of the chamber 1038 or one end of the spring 1012 and a capacitor may be mounted on the printed circuit board 1020. A change in the spacing between the metal piece and the capacitor will change the capacitance in a measurable amount corresponding to the amount of moisture. In yet another form, the sensor 1004 uses an inductor wrapped around the chamber 1038 or spring 1012 and coupled to the printed circuit board 1020. Expansion of the chamber 1038 changes the inductance in an amount that may be detected by appropriate electronics on the printed circuit board 1020, providing an analog continuous measurement corresponding to the amount of moisture and/or an indication of exceeding a threshold. In yet another form, the sensor 1004 may use a graphite stack resistor coupled to the printed circuit board 1020 and that engages the spring 1012 when the chamber 1038 expands. Expansion of the chamber 1038 changes the force applied to the graphite stack resistor by the spring 1012, changes its electrical resistance, and is detected by appropriate electronics on the printed circuit board 1020, providing an analog continuous measurement corresponding to the amount of moisture. In yet another form, the sensor 1004 uses a magnet on a surface of the chamber 1038 and a Hall effect device mounted on the printed circuit board 1020. Expansion of the chamber 1038 causes the spacing between the magnet and the Hall effect device to change, changing the output of the Hall effect device. This change in the output of the Hall effect device is detected by appropriate electronics on the printed circuit board 1020. In yet another form, the sensor 1004 uses a linear potentiometer, which may include a wiper of a fixed resistive sensing element. Expansion of the chamber 1038 changes the position of the linear wiper on the potentiometer, changing its resistance. This change in resistance is detected by appropriate electronics on the printed circuit board 1020. In each of these forms, the sensor 1004 may provide an analog continuous measurement corresponding to the amount of moisture and may signal whether a moisture threshold has been exceeded. As should be evident, these electronic embodiments may be used to provide moisture level data for understand the actual moisture level value in a number of different applications, including, for example, soil laboratory testing, soil surveying (construction, geology, forestry etc.), agriculture irrigation management, potted plant monitoring, golf course irrigation management, control zone management, park and municipality irrigation management, and other large to medium size commercial irrigation management.

Further, as should be evident, additional options and modifications are available for these electronic embodiments. For example, they may include an actual visual display of the output. As another example, they may be provided with a wireless connection to provide data to a user directly via smart phone, provide data to a control system, or provide data to other internet or local based systems that could use the soil moisture level information in order to irrigate, not irrigate, and/or adjust/suggest the irrigation time or amount of water needed.

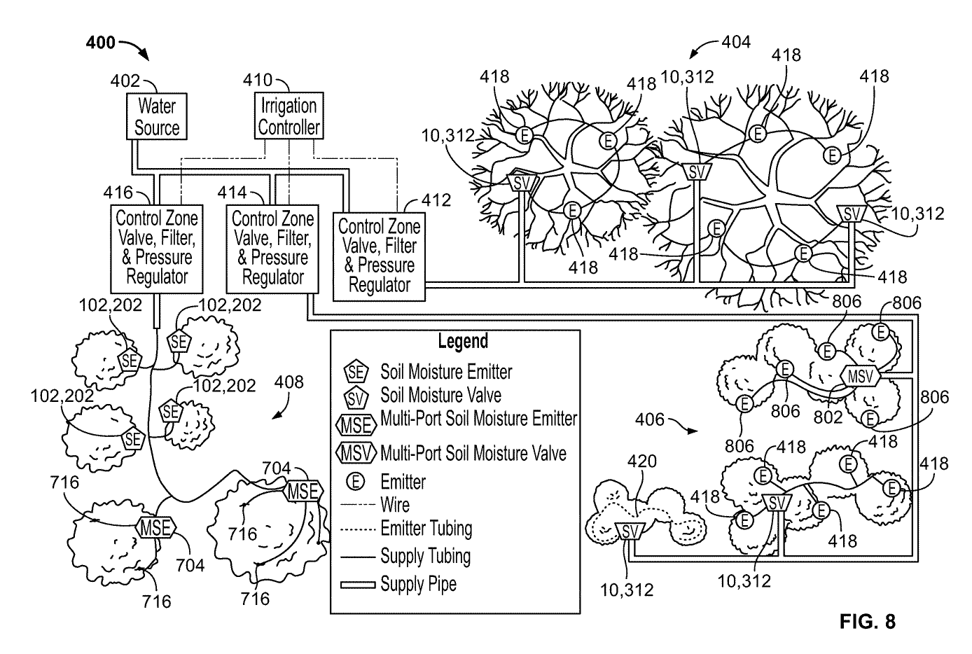

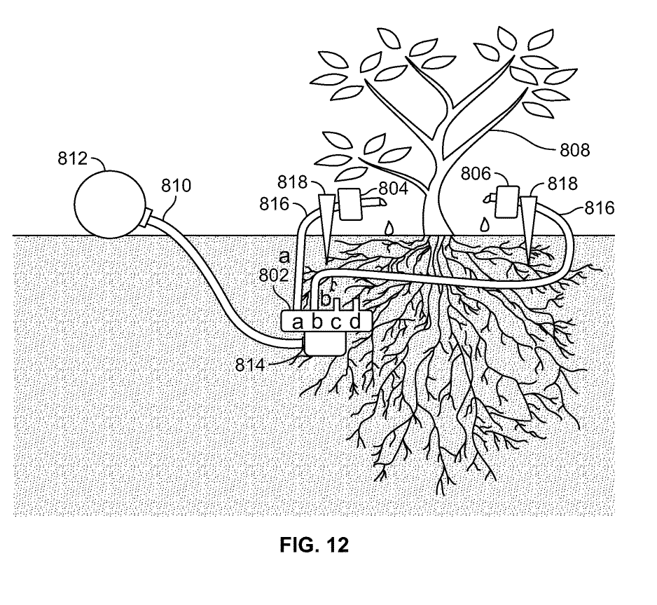

FIG. 8 illustrates an exemplary irrigation system 400 that includes a water source 402 supplying three irrigation zones 404, 406, 408. An irrigation controller 410 controls three control valves 412, 414, 416, one for each of the three zones 404, 406, 408, respectively. The first zone 404 includes three soil moisture valves, such as valve 10 or main control valve 312 controlled by pilot valve 310, with each controlling a subzone with emitters 418 connected through tubing to the proper location for watering. The second zone 406 includes two subzones each controlled by a soil moisture valve, such as valve 10 or main control valve 312 controlled by pilot valve 310. One of the subzones include emitter tubing 420, and a second subzone includes a number of emitters 418 connected through tubing to the proper location for watering. A third subzone includes a single multi-outlet valve unit 802, as described below with reference to FIG. 12. Emitters 806 are connected to the valve with conduit to position the emitters 806 at the proper location for watering. The third zone 408 includes four emitters equipped with an embedded valve, such as that described above for emitters 102, 202, and two multi-port emitters each with an embedded soil moisture valve 704 with conduit outlets 716 at the proper location for watering, as described below with reference to FIG. 1I. With this system, the irrigation controller 410 could be eliminated or set to generous watering schedules in that each of the zones 404, 406, 408 are controlled by an on-demand valve. Alternatively, this layout may be used without the controller and electrically controlled zone valves and be controlled solely by the on-demand valves.

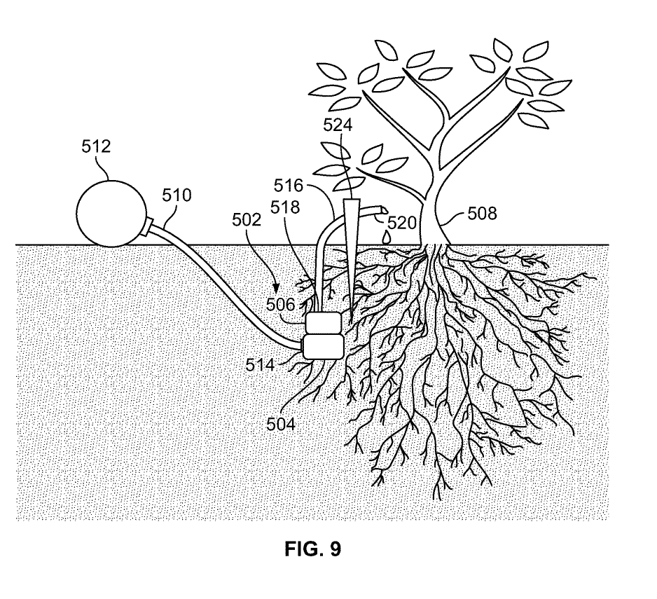

In FIG. 9, there is shown an application of a combined moisture sensing valve/emitter unit 502. The unit 502 combines the valve 504 with the emitter 506. Examples of such combined units include units 102 and 202 described above. The moisture sensing emitter 502 is buried at a depth and distance from a plant 508 that provides a good indication of the soil moisture levels for that specific plant. One position may be toward the edge of the root cluster and at mid-depth along the root cluster. Other positions may be selected depending on the plant type, soil type, amount of shade or sunlight and other basic factors of the landscape situation. Tubing 510 connects supply tubing 512 to the valve inlet 514. Tubing 516 is connected to an outlet 518 of the emitter 506 which runs to the surface. The outlet tubing 516 should be in a location that would normally be specified for drip irrigation for the plant material with drip irrigation. The tubing's outlet end 520 may be held in position by a stake 524. Additional examples are emitters 102, 202 shown in zone 408 of FIG. 8.

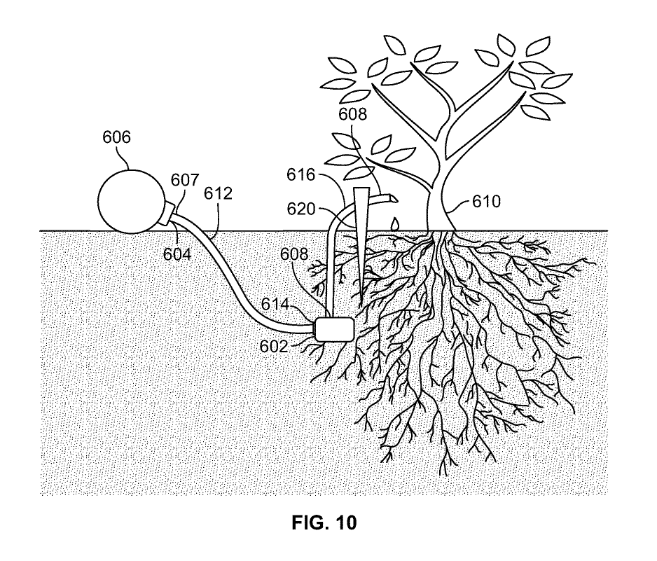

In FIG. 10, there is shown an application of a moisture sensing valve 602, such as, for example, valve 10 described above, and an emitter 604 as a separate unit, such as, for example, Rain Bird's Xeri Bug Drip Emitter (both pressure compensating and non-pressure compensating). The emitter 604 could be installed at the supply tubing 606, as shown, or at the tubing outlet 608 (see, e.g., FIG. 12) at a desired watering location for a particular plant 610. The valve 602 is buried at a depth and distance from the plant 610 that provides a good indication of the soil moisture levels for that specific plant. One position may be toward the edge of the root cluster and at mid-depth along the root cluster. Other positions may be selected depending on the plant type, soil type, amount of shade or sunlight and other basic factors of the landscape situation. Tubing 612 connects the supply tubing 606 from the outlet of the emitter 604 to the inlet 614 of the valve 602. Tubing 616 is connected to an outlet 618 of the valve 602 and runs to the surface. The outlet 608 of the tubing 616 should be in a location that would normally be specified for drip irrigation for the plant 610. The tubing outlet 608 (with or without an emitter) could be held in place using a stake 620.

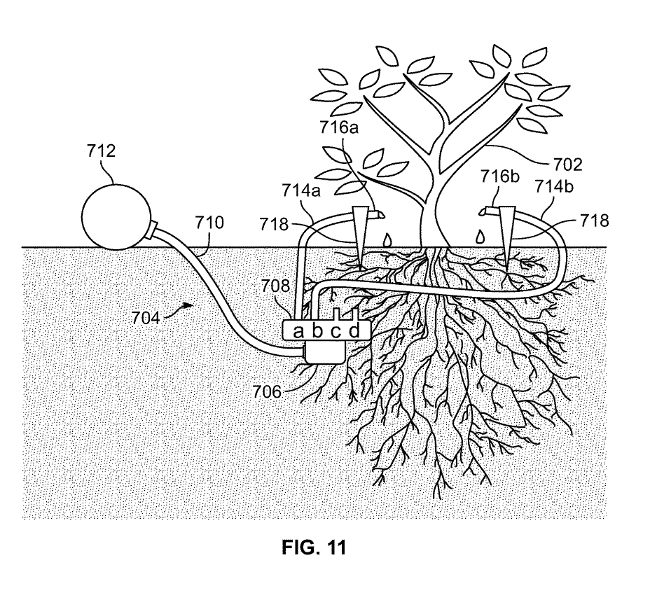

As illustrated in FIG. 11, multiple emission points may be needed to properly irrigate a larger plant 702. A single multi-outlet valve/emission unit 704 could be used where the soil moisture for the plant was sensed at one location but could allow/disallow irrigation to multiple points from the emitter. More specifically, the single multi-outlet valve/emission unit 704 could contain both the on-off sensing valve 706 which uses osmotic potential as described above, such as valve 10 or the valves of drip emitters 102 or 202, and the multi-outlet emitter 708, such as, for example. Rain Bird's Multi-Outlet Xeri Bug or EMT-6XERI. The unit 704 is buried at a depth and distance from the plant 702 that provides a good indication of the soil moisture levels for that specific plant. One position may be toward the edge of the root cluster and at mid-depth along the root cluster. Other positions may be selected depending on the plant type, soil type, amount of shade or sunlight and other basic factors of the landscape situation. Tubing or hard plumbing 710 can connect to the unit 704 inlet to a supply line 712. Additional tubing 714a, 714b is connected to one or more of the multiple outlets denoted as “a”-“d” of the multi-outlet emitter 708. In this example, outlets “a” and “b” are used, while outlets “c” and “d” are not needed for this plant 702. All or at least three of the outlets “a”-“d” can be molded closed from the factory. To open the outlet, the plastic blocking the outlet can be removed by cutting or piercing it open. For example, the plastic blocking outlets “a” and “b” has been removed, while the plastic blocking outlets “c” and “d” remain in place. Alternatively, each outlet could be controlled by an individual valve, such as a ball valve. The tubing 714a, 714b extends from the outlets “a” and “b” to a location that is specified for the particular plant 702 for drip irrigation. The outlet ends 716a, 716b of the tubing 714a, 714b may be held in place with a stake 718 at the position where irrigation is desired. An example is the multi-outlet valve/emission unit 704 in zone 408 of FIG. 8.

Alternatively, as illustrated in FIG. 12, a multi-outlet moisture sensing valve 802 is shown separate from a set of emitter devices 804, 806. The multi-outlet moisture sensing valve 802 operates using the same osmotic potential as described above. For example, it may include a single valve, such as the valve 10 or the valves of drip emitters 102 or 202, that when open supplies a manifold leading to each of the outlets “a”-“d.” Alternatively, an individual valve, such as the valve 10, 10A, or the valves of emitters 102, 202, could be supplied for each outlet.

All or least all but one of the outlets can be factory closed during the molding process and opened during installation as needed. For instance, as illustrated in FIG. 12, only outlets “a” and “b” would be opened by removing the blockage through cutting or piercing and the other two, “c” and “d,” would remain molded shut. Alternatively, each of the outlets could be associated with a manual valve, such as a ball valve, to open and close the outlet.

The multi-outlet moisture sensing valve 802 is buried at a depth and distance from a plant 808 that provides a good indication of the soil moisture levels for that specific plant. One position may be toward the edge of the root cluster and at mid-depth along the root cluster. Other positions may be selected depending on the plant type, soil type, amount of shade or sunlight and other basic factors of the landscape situation. Tubing or hard plumbing 810 can connect to a supply tube 812 and an inlet 814 of the multi-outlet moisture sensing valve. Tubing 816 is connected to one or multiple outlets of the multi-outlet sensing valve 802. In this example outlets “a” and “b” are used, but outlets “c” and “d” are not needed for this plant. The outlet ends of the tubing 816 and their attached emitter devices 804, 806 should be positioned at a location specified for the plant 808 for drip irrigation and may be held in place with a stake 818. An example is the multi-outlet soil moisture valve unit 802 and emitters 806 in zone 406 of FIG. 8.

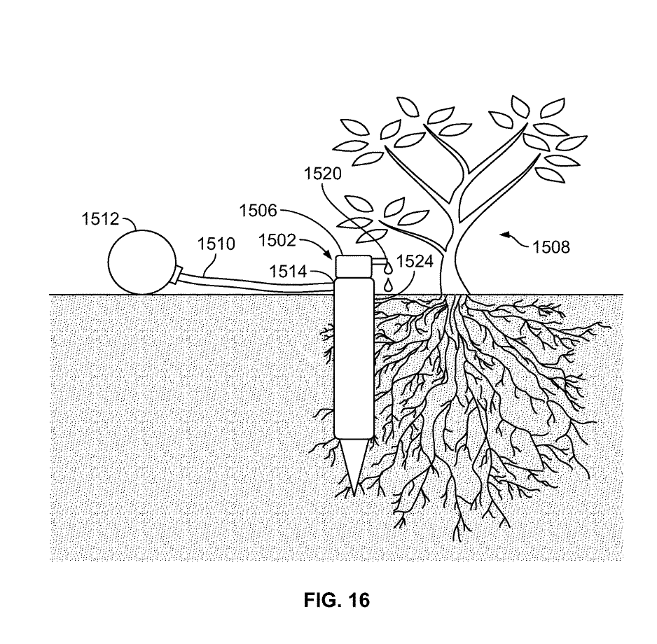

FIGS. 16-20 show alternative embodiments to the moisture sensing valve and emitter units shown in FIGS. 9-12. As addressed below, in these alternative embodiments, the valves and emitters have been combined with the stakes to form an integrated unit. Other than this integration, the remainder of the discussion relating to FIGS. 9-12 applies generally to FIGS. 16-20.

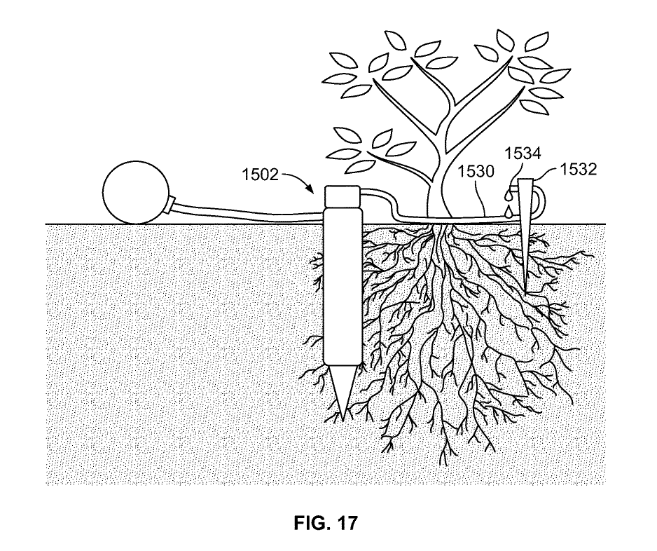

In FIG. 16, there is shown an application of an integrated moisture sensing emitter stake unit 1502. The unit 1502 combines the valve with the stake 1524 (such as, for example, valves 10, 10A described above), and also with the emitter 1506. The moisture sensing emitter stake unit 1502 is buried at a depth and distance from a plant 1508 that provides a good indication of the soil moisture levels for that specific plant. Tubing 1510 connects supply tubing 1512 to the valve inlet 1514. The tubing's outlet end 1520 at the emitter 1506 is held in position by the stake 1524. FIG. 17 shows an additional embodiment making use of tubing 1530 from the stake unit 1502 to a second stake 1532 supporting the outlet end 1534.

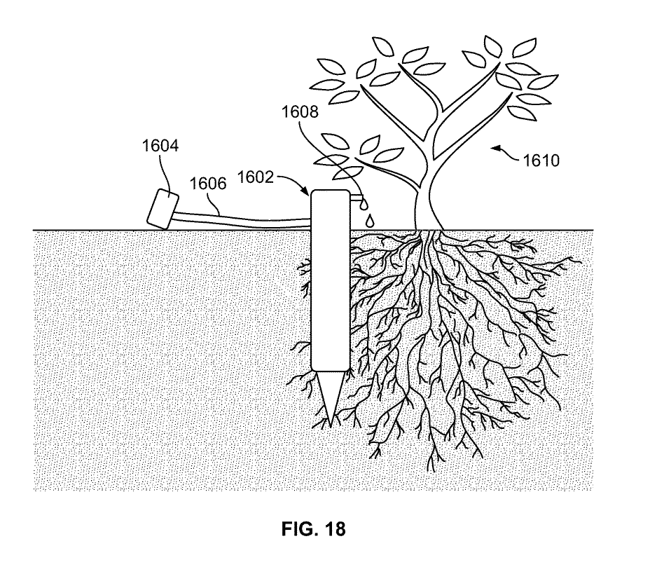

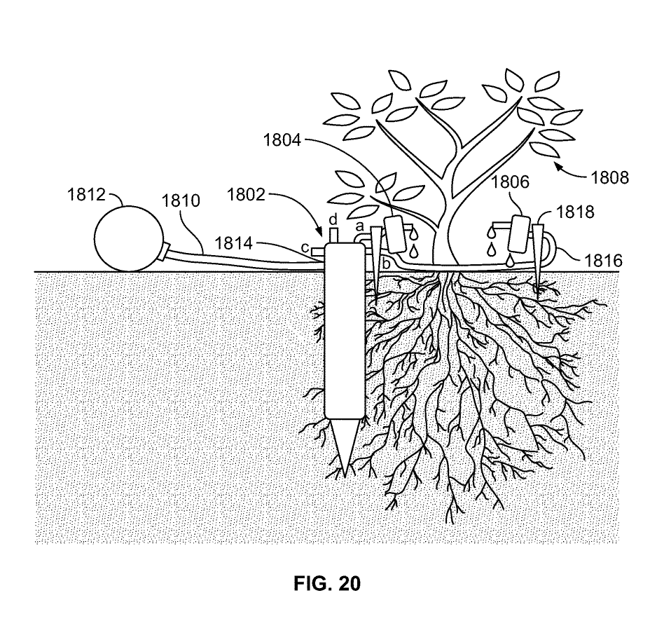

In FIG. 18, there is shown an application of an integrated moisture sensor valve stake unit 1602, such as, for example, valves 10, 10A described above, and an emitter 1604 as a separate unit, such as, for example, Rain Bird's Xeri Bug Drip Emitter (both pressure compensating and non-pressure compensating). The emitter 1604 could be installed at the supply tubing 1606, as shown, or at the tubing outlet 1608 (see, e.g., FIG. 20) at a desired watering location for a particular plant 1610. The valve 1602 is buried at a depth and distance from the plant 1610 that provides a good indication of the soil moisture levels for that specific plant.

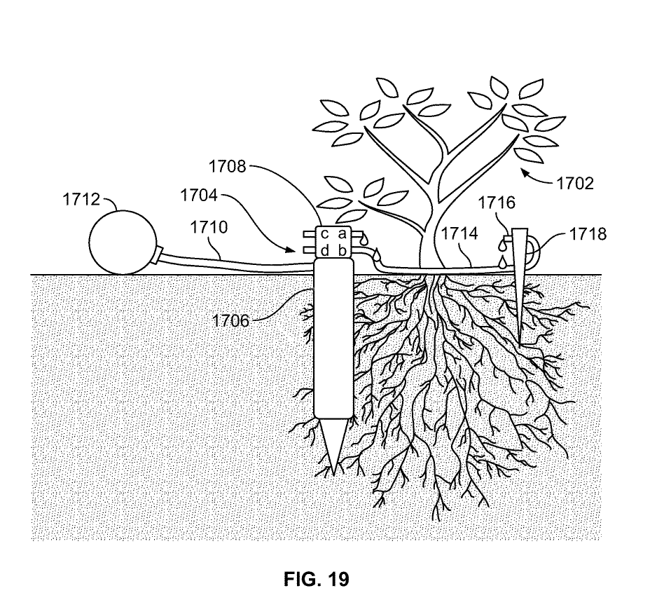

As illustrated in FIG. 19, multiple emission points may be needed to properly irrigate a larger plant 1702. An integrated multi-outlet moisture sensing emitter stake unit 1704 could be used where the soil moisture for the plant was sensed at one location but could allow/disallow irrigation to multiple points from the emitter. More specifically, the single multi-outlet valve/emission unit 1704 could contain both the on-off sensing stake valve 1706 which uses osmotic potential as described above, such as stake valves 10, 10A, and the multi-outlet emitter 1708, such as, for example, Rain Bird's Multi-Outlet Xeri Bug or EMT-6XERI. The unit 1704 is buried at a depth and distance from the plant 1702 that provides a good indication of the soil moisture levels for that specific plant. Tubing or hard plumbing 1710 can connect to the unit 1704 inlet to a supply line 1712. Additional tubing 1714 is connected to one or more of the multiple outlets denoted as “a”-“d” of the multi-outlet emitter 1708. In this example, outlets “a” and “b” are used, while outlets “c” and “d” are not needed for this plant 1702. Outlets “a” and “b” are opened and “c” and “d” remain closed as discussed above. The tubing 1714 extends from the outlet “b” to a location that is specified for the particular plant 1702 for drip irrigation. The outlet end 1716 of the tubing 1714 may be held in place with a second stake 1718 at the position where irrigation is desired.

Alternatively, as illustrated in FIG. 20, an integrated multi-outlet moisture sensing valve stake unit 1802 is shown separate from a set of emitter devices 1804, 1806. The multi-outlet moisture sensing valve stake unit 1802 operates using the same osmotic potential as described above. For example, it may include a single valve, such as the valves 10, 10A, that when open supplies a manifold leading to each of the outlets “a”-“d.” Alternatively, an individual valve, such as the valves 10, 10A, could be supplied for each outlet. The multi-outlet moisture sensing valve stake unit 1802 is buried at a depth and distance from a plant 1808 that provides a good indication of the soil moisture levels for that specific plant. Tubing or hard plumbing 1810 can connect to a supply tube 1812 and an inlet 1814 of the multi-outlet moisture sensing valve stake unit 1802. Tubing 1816 is connected to one or multiple outlets of the multi-outlet sensing valve 1802. In this example outlets “a” and “b” are used (open), but outlets “c” and “d” are not needed for this plant (remain closed). The outlet ends of the tubing 1816 and their attached emitter devices 1804, 1806 should be positioned at a location specified for the plant 1808 for drip irrigation and may be held in place with a second stake 1818.

As should be evident, there are a number of modifications and additions that may be made to the devices described in this application. The devices may be in various preferred product forms, such as buried devices, integrated into a stake, etc. The valve functionality may be adjusted as desired, such as a valve adjustable between fully on and off positions or a valve with flow varying from fully open to just shy of fully closed. Further, the devices may be modified to accommodate their operating environments, including different temperatures, soil types, plant types, maximum and minimum required flow capability, etc. The devices may also be modified so as to accommodate any of various installation methods. Moreover, they may include some type of indicators and methods for detecting the presence of the device or showing that the device has been installed and is functional. In addition, it is contemplated that a type of installation tool and method may be used to ensure the device is buried at a desired depth.

There are additional options and embodiments available that may be used in other irrigation contexts. For example, the devices may be used to get an understanding of different moisture levels at different depth levels or across a terrain. For instance, a user may utilize multiple sensing tips spaced out along a vertical shaft in order to understand the water profile at different depths and to understand the movement of water through the soil, such as for agriculture applications. Alternatively, a user may utilize multiple sensors spread out in a grid or on a flexible tube that could be buried at one depth to provide an understanding of the moisture levels around a plant or among many plants.

It will be understood that various changes in the details, materials, and arrangements of parts and components which have been herein described and illustrated by way of example in order to explain the nature of the subject matter may be made by those skilled in the art within the principles and scope of the invention as expressed in the appended claims. Furthermore, while various features have been described with regard to a particular embodiment, it will be appreciated that features described for one embodiment also may be incorporated into the other described embodiments.

1. A valve comprising:
an inlet;
an outlet;
a valve seat intermediate the inlet and the outlet;
a valve member biased away from the valve seat to an open position;
a water soluble material in operational engagement with the valve member to move the valve member relative to the valve seat; and
a semi-permeable member adjacent the water soluble material, the membrane being permeable to water and impermeable to the water soluble material.

2. The valve in accordance with claim 1 further comprising a porous member adjacent the semi-permeable member.

3. The valve in accordance with claim 2 wherein the porous member material is selected from the group consisting of ceramic, porous sintered metal, porous metal injection molding, a screen, screen/fabric combinations, or some combination thereof.

4. The valve in accordance with claim 1 wherein the valve member comprises a plunger.

5. The valve in accordance with claim 4 further comprising a first spring providing a first biasing force against the plunger and away from the valve seat.

6.-7. (canceled)

8. The valve in accordance with claim 1 wherein the water soluble material comprises a polymer material.

9. The valve in accordance with claim 8 wherein the polymer material is selected from the group consisting of polyethylene glycol, polyacrylamide, polyvinyl-pyrrolidone and polyethylene oxide.

10. (canceled)

11. The valve in accordance with claim 4 further comprising a chamber containing the water soluble material, and the chamber being variable in size depending on the operational engagement of the water soluble material with the plunger.

12. The valve in accordance with claim 11 wherein the chamber has an adjustable at rest size independent of the operational engagement of the water soluble material with the plunger.

13. (canceled)

14. The valve in accordance with claim 1 further comprising a bypass from the inlet to the outlet to allow flow through the valve when the valve member is in engagement with the valve seat.

15. (canceled)

16. The valve in accordance with claim 1, wherein the inlet communicates with a pressure chamber of a supply valve, and the position of the valve member relative to the valve seat controls operation of the supply valve.

17. (canceled)

18. An irrigation emission device comprising
an inlet;
at least one outlet;
a valve seat intermediate the inlet and the outlet;
a valve member biased away from the valve seat;
a water soluble material in operational engagement with the valve member to move the valve member relative to the valve seat; and
a semi-permeable membrane adjacent the water soluble material, the membrane being permeable to water and impermeable to the water soluble material.

19. The irrigation emission device in accordance with claim 18 further comprising a porous member adjacent the semi-permeable member.

20. The irrigation emission device in accordance with claim 19 wherein the porous member material is selected from the group consisting of ceramic, porous sintered metal, porous metal injection molding, screen, screen/fabric combinations, or some combination thereof.

21. The irrigation emission device in accordance with claim 18 wherein the valve member is a first diaphragm having a first biasing force away from the valve seat.

22. (canceled)

23. The irrigation emission device in accordance with claim 18 wherein the water soluble material comprises a polymer material.

24. The irrigation emission device in accordance with claim 23 wherein the polymer material is selected from the group consisting of polyethylene glycol, polyacrylamide, polyvinyl-pyrrolidone and polyethylene oxide.

25. (canceled)

26. The irrigation emission device in accordance with claim 18 further comprising a chamber containing the water soluble material, and the chamber being variable in size depending on the operational engagement of the water soluble material with the valve member.

27. The irrigation emission device in accordance with claim 26 wherein the chamber has an adjustable at rest size independent of the operational engagement of the water soluble material with the valve member.

28. (canceled)

29. The irrigation emission device in accordance with claim 18 further comprising a bypass from the inlet to the outlet to allow flow through the device when the valve member is in engagement with the valve seat.

30. (canceled)

31. The irrigation emission device in accordance with claim 18 further comprising a pressure regulator downstream of the valve member.

32.-34. (canceled)

35. A device for regulating irrigation in response to soil moisture comprising:
a variable sized chamber;
a water soluble material in the chamber;
a path allowing water to flow in and out of the chamber;
a variation in chamber size based on an osmotic relationship between the water in the chamber and soil moisture; and
the size of the chamber controlling irrigation.

36. The device in accordance with claim 35 wherein the size of the chamber being coordinated with a predetermined electrical signal to control irrigation.

37. The device in accordance with claim 36 wherein the electrical signal is used to adjust or interrupt watering schedules.

38. The device in accordance with claim 37 wherein the electrical signal is transmitted to a controller.

39. The device in accordance with claim 35 wherein the size of the chamber being a first predetermined size that opens a valve.

40. The device in accordance with claim 39 wherein the size of the chamber being a second predetermined size that closes a valve.

41. The device in accordance with claim 40 further comprising a bypass to allow flow through the valve when closed.

42. The device in accordance with claim 35 further comprising a sensor configured to make measurements corresponding to soil moisture based on the degree of expansion of the chamber.

43. The device in accordance with claim 42 wherein the sensor is selected from the group consisting of strain gauges, capacitors, inductors, resistors, Hall effect sensors, linear potentiometers, and linear variable differential transformers.
